(19) United States
(12) Patent Application Publication
(10) Pub. No.: US 2024/0278369 A1
(43) Pub. Date: Aug. 22, 2024

(54) MACHINE TOOL

(71) Applicant: FUJI CORPORATION, Aichi (JP)

(72) Inventor: Daisuke FUKUOKA, Toyota-shi (JP)

(73) Assignee: FUJI CORPORATION, Aichi (JP)

(21) Appl. No.: 18/567,072

(22) PCT Filed: Jul. 7, 2021
(86) PCT No.: PCT/JP2021/025592

§ 371 Date: Dec. 5, 2023

(51) Int. Cl. B23Q 5/28

(52) U.S. Cl. CPC B23Q 5/28

(57) ABSTRACT

A machine tool includes a first loader configured to convey a workpiece to a first machining section, a second loader configured to convey the workpiece to a second machining section, and a workpiece conveyance device configured to deliver the workpiece between the first loader and the second loader. A first reversing unit, a second reversing unit, and a shift unit are attachable to the workpiece conveyance device. With the first and second reversing units attached, the machine tool reverses the workpiece received from the second loader to the first reversing unit by the first and second reversing units and delivers the workpiece from the second reversing unit to the first loader. With the shift unit attached, the machine tool delivers the workpiece from the shift unit to the first loader while maintaining orientation of the workpiece received from the second loader to the shift unit.

### TECHNICAL FIELD

The present disclosure relates to delivery of a workpiece in a machine tool.

### BACKGROUND ART

Conventionally, various machine tools for delivering a workpiece between multiple machining sections have been proposed. For example, Patent Literature 1 below discloses a machine tool including a first spindle chuck provided on a first spindle, a second spindle chuck provided on a second spindle, and a loading device that delivers a workpiece between the first and second spindle chucks. The machine tool of Patent Literature 1 includes a workpiece reversing device that reverses a workpiece received from a loading device and delivers the reversed workpiece to the loading device.

### PATENT LITERATURE

Patent Literature 1: JP-A-S63-144902

### BRIEF SUMMARY

### Technical Problem

In the machine tool of Patent Literature 1 described above, the delivery of workpiece with each of the first and second spindle chucks is performed by one loading device. Therefore, for example, after the workpiece is delivered from the first spindle chuck to the loading device, it is difficult for the loading device to supply the workpiece to a first spindle device until the workpiece is conveyed to a second spindle device. For example, while the workpiece is reversed by the workpiece reversing device, a waiting time of the loading device may occur, and a time until the next workpiece is set in the first spindle device may be delayed.

The present disclosure has been made in view of the above problem, and an object of the present disclosure is to provide a machine tool capable of quickly supplying a workpiece to a machining section by a loader.

### Solution to Problem

According to an aspect of the present disclosure, there is provided a machine tool including: a first loader configured to convey a workpiece to a first machining section configured to perform machining on the workpiece: a second loader configured to convey the workpiece to a second machining section configured to perform machining on the workpiece: a workpiece conveyance device configured to deliver the workpiece between the first loader and the second loader; and a control section, in which a first reversing unit, a second reversing unit, and a shift unit are attachable to the workpiece conveyance device, and, the control section executes a reversing control of, when the first reversing unit and the second reversing unit are attached, delivering the workpiece from the first loader to the first reversing unit, rotating the first reversing unit in a state of holding the delivered workpiece, delivering the workpiece from the rotated first reversing unit to the second reversing unit, rotating the second reversing unit in a state of holding the delivered workpiece, and delivering the workpiece from the rotated second reversing unit to the second loader, and a shift control of, when the shift unit is attached, delivering the workpiece from the first loader to the shift unit and delivering the workpiece from the shift unit to the second loader while maintaining orientation of the delivered workpiece.

### Advantageous Effects

According to the machine tool of the present disclosure, the workpiece can be conveyed to the first machining section by the first loader, and the workpiece can be conveyed to the second machining section by the second loader. Accordingly, for example, while the workpiece conveyance device and the first loader are working, a new workpiece can be supplied to the second machining section by the second loader. Accordingly, the workpiece can be quickly supplied to the first and second machining sections by the first and second loaders. The conveyance of the workpiece between the first and second loaders can be executed by the first and second reversing units and the shift unit. By conveying the workpiece by the first and second reversing units, the workpiece can be reversed and delivered from the second loader to the first loader. By conveying the workpiece by the shift unit, the workpiece can be delivered from the second loader to the first loader while maintaining the posture of the workpiece.

### BRIEF DESCRIPTION OF DRAWINGS

FIG. 1 is a front view of a machine tool according to the present embodiment.

FIG. 2 is a block diagram of the machine tool.

FIG. 3 is a perspective view and a partially enlarged view of the workpiece conveyance device and the second loader.

FIG. 4 is a perspective view of a workpiece conveyance device to which first and second reversing units are attached as viewed from the front side.

FIG. 5 is a perspective view of the workpiece conveyance device to which the first and second reversing units are attached as viewed from the front side.

FIG. 6 is a perspective view of the workpiece conveyance device to which the first and second reversing units are attached as viewed from the rear side.

FIG. 7 is a perspective view of the first reversing unit.

FIG. 8 is a perspective view of the second reversing unit.

FIG. 9 is a perspective view of the workpiece conveyance device to which a shift unit is attached as viewed from the front side.

FIG. 10 is a perspective view of the shift unit.

FIG. 11 is a view illustrating an operation of the workpiece conveyance device in reversing control.

FIG. 12 is a view illustrating the operation of the workpiece conveyance device in the reversing control.

FIG. 13 is a view illustrating the operation of the workpiece conveyance device in the shift control.

FIG. 14 is a perspective view illustrating a workpiece conveyance device of another example.

### DESCRIPTION OF EMBODIMENTS

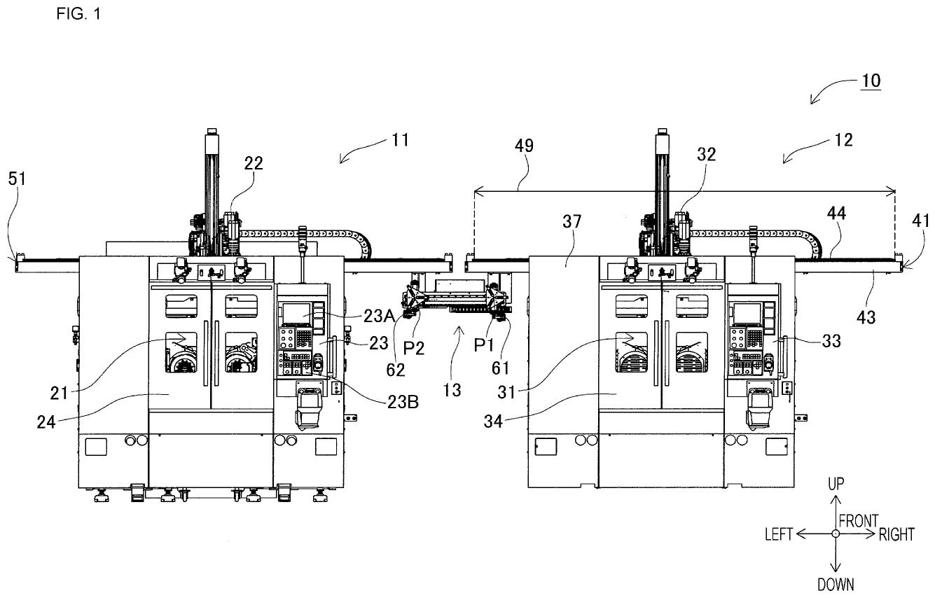

Hereinafter, an embodiment of a machine tool according to the present disclosure will be described with reference to the drawings. FIG. 1 illustrates a front view of machine tool 10 of the present embodiment. As illustrated in FIG. 1, machine tool 10 includes first machine tool 11, second machine tool 12, and workpiece conveyance device 13. In the following description, as illustrated in FIG. 1, a machine width direction of machine tool 10 is referred to as a left-right direction, a direction parallel to an installation surface of machine tool 10 and perpendicular to the left-right direction is referred to as a front-rear direction, and a direction perpendicular to the left-right direction and the front-rear direction is referred to as an up-down direction based on a direction in which machine tool 10 is viewed from the front surface.

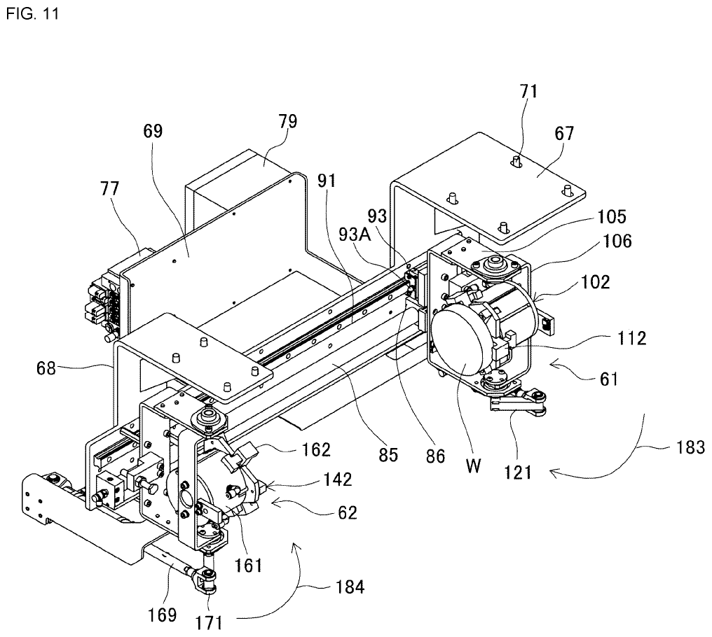

First machine tool 11 includes first machining section 21, first loader 22, and first operation section 23. First machining section 21 includes spindle device (not illustrated) that grips and rotates workpiece W (see FIG. 11), a turret device (not illustrated) that machines workpiece W gripped by the spindle device, and the like. The user can access a machining space of first machining section 21 by opening front door 24 provided on a front surface of first machine tool 11, and can check a machining state of workpiece W, replace the tool of the turret device, and the like.

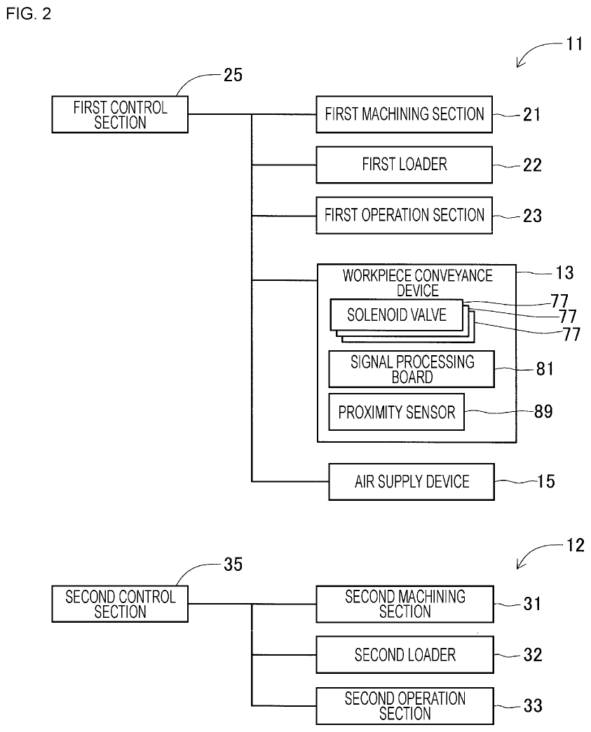

First operation section 23 includes touch panel 23A, operation switch 23B, and the like, and receives an operation input from a user and changes the display of touch panel 23A. First control section 25 (see FIG. 2) that controls the operation of first machine tool 11 is provided on the front side of first machine tool 11 and behind first operation section 23. As illustrated in FIG. 2, first control section 25 is connected to first machining section 21, first loader 22, first operation section 23, workpiece conveyance device 13, and air supply device 15, and can control the operation of each device.

Second machine tool 12 is disposed on the right side of first machine tool 11 with workpiece conveyance device 13 interposed therebetween. Second machine tool 12 has the same configuration as first machine tool 11. Therefore, in the description of second machine tool 12, the description of the same components as those of first machine tool 11 will be appropriately omitted. Second machine tool 12 includes second machining section 31, second loader 32, second operation section 33, and second control section 35 (see FIG. 2). Similarly to first machining section 21, second machining section 31 machines workpiece W gripped by a spindle device (not illustrated) with a tool of the turret device (not illustrated). Front door 34 capable of accessing the machining space of second machining section 31 is provided on the front surface of second machine tool 12. Second control section 35 is provided, for example, on the front side of second machine tool 12 (front surface of device cover 37 described later) and behind second operation section 33, and can control second machining section 31, second loader 32, and second operation section 33. As illustrated in FIG. 1, first operation section 23 of first machine tool 11 and first control section 25 provided behind first operation section 23 are disposed at positions closer to workpiece conveyance device 13 in the left-right direction than second operation section 33 of second machine tool 12 and second control section 35 provided behind second operation section 33.

### (First and Second Loaders 22 and 33)

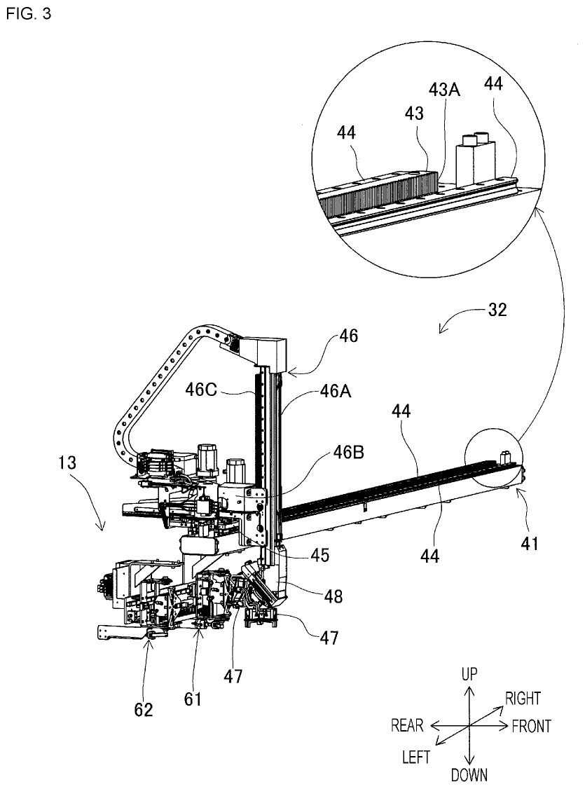

Next, first and second loaders 22 and 33 will be described. First loader 22 of first machine tool 11 has the same configuration as second loader 32 of second machine tool 12. Therefore, in the following description, second loader 32 will be mainly described, and the description of first loader 22 will be appropriately omitted. FIG. 3 is a perspective view of workpiece conveyance device 13 and second loader 32. Second loader 32 is, for example, a gantry type workpiece conveyance device, and is provided on an upper portion of second machine tool 12. As illustrated in FIG. 3, second loader 32 includes rail base 41 fixed to an upper portion of a frame member (not illustrated) provided in device cover 37 (see FIG. 1) of second machine tool 12. As illustrated in an enlarged view of FIG. 3, an upper surface of rail base 41 includes, for example, one traveling rack 43 extending along the left-right direction, and two traveling rails 44 arranged to sandwich traveling rack 43 therebetween in the width direction. Traveling rack 43 and two traveling rails 44 are disposed on rail base 41 along the left-right direction in a state of being parallel to each other. Multiple tooth portions 43A are formed on a side surface of traveling rack 43 at predetermined intervals in the left-right direction.

Second loader 32 includes traveling table 45, lifting and lowering device 46, and pair of chuck mechanisms 47. Second loader 32 is configured to move workpiece W (see FIG. 11) gripped by pair of chuck mechanisms 47 in three axial directions. Specifically, traveling table 45 is configured to be able to slide along two traveling rails 44, and moves in the left-right direction along traveling rails 44 by driving a traveling motor incorporated in traveling table 45 based on the control of second control section 35 of second machine tool 12. For example, the traveling motor moves traveling table 45 to any position in the left-right direction by meshing a pinion (not illustrated) fixed to an output shaft with tooth portion 43A provided in traveling rack 43.

Lifting and lowering device 46 includes lifting and lowering arm 46A which is attached to traveling table 45 and extends in the up-down direction. Chuck main body portion 48 is attached to a lower end portion of lifting and lowering arm 46A. Pair of chuck mechanisms 47 are attached to chuck main body portion 48. Lifting and lowering device 46 includes lifting and lowering motor 46B as a drive source. An output shaft of lifting and lowering motor 46B is drivingly coupled to rack 46C formed on lifting and lowering arm 46A via a pinion (not illustrated). Lifting and lowering device 46 drives lifting and lowering motor 46B based on the control of second control section 35 to change a position of lifting and lowering arm 46A in the up-down direction. Accordingly, the position of chuck main body portion 48 (pair of chuck mechanisms 47) in the up-down direction is changed according to the movement of lifting and lowering arm 46A. FIG. 3 illustrates a state in which the position of chuck main body portion 48 (pair of chuck mechanisms 47) in the up-down direction is aligned with the position of first reversing unit 61 of workpiece conveyance device 13 described later.

Pair of chuck mechanisms 47 are attached to chuck main body portion 48 so as to face in different directions. For example, an air rotary actuator is incorporated in chuck main body portion 48. Chuck main body portion 48 drives the rotary actuator based on the control of second control section 35 to rotate pair of chuck mechanisms 47 about a predetermined rotation axis. Accordingly, the positions of pair of chuck mechanisms 47 are changed from each other, and chuck mechanisms 47 that delivers workpiece W between workpiece conveyance device 13 and the spindle device of second machine tool 12 is switched. Each of pair of chuck mechanisms 47 incorporates an air cylinder as a drive source for opening and closing the chuck. Chuck mechanism 47 grips workpiece W or releases the gripping of workpiece W based on the driving of the air cylinder.

Second loader 32 moves based on the control of second control section 35 to execute the delivery of workpiece W. For example, second loader 32 moves along the left-right direction with ranges of both ends of rail base 41 in the left-right direction illustrated in FIG. 1 as movable ranges 49. Second loader 32 delivers workpiece W between workpiece conveyance device 13 and second loader 32 at first position P1. First position P1 is a position on the left end portion of movable range 49 (rail base 41). Second loader 32 moves lifting and lowering arm 46A downward at a central portion of movable range 49 in the left-right direction, and delivers workpiece W between the spindle device of second machining section 31 and second loader 32. In addition, for example, when another workpiece conveyance device 13 or a machine tool is disposed on the right side of second machine tool 12, second loader 32 delivers workpiece W between another workpiece conveyance device 13 or the like and second loader 32 on the right end portion of movable range 49.

Similarly, first loader 22 of first machine tool 11 executes the delivery of workpiece W based on the control of first control section 25. First loader 22 delivers workpiece W between workpiece conveyance device 13 and first loader 22 at second position P2, which is the right end portion of rail base 51 illustrated in FIG. 1. First loader 22 can deliver workpiece W between first machining section 21 and first loader 22 at a central portion in the left-right direction, and can deliver workpiece W between another device and first loader 22 on the left end portion.

### (Workpiece Conveyance Device 13)

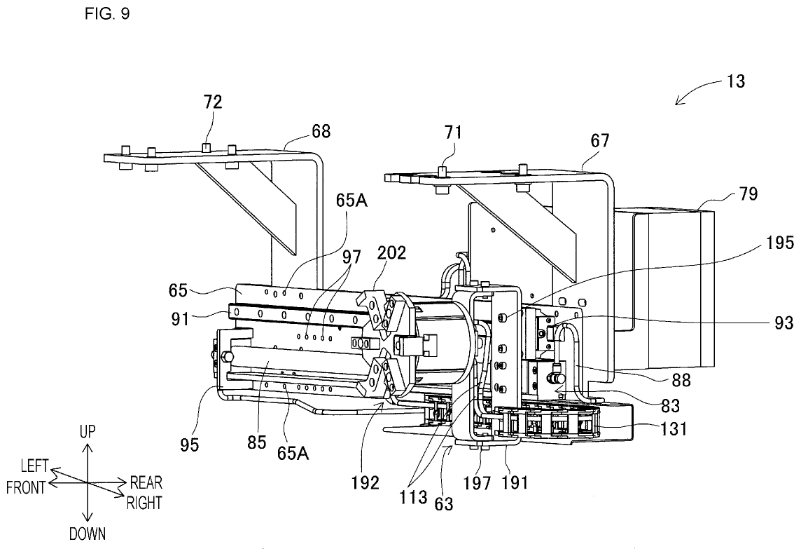

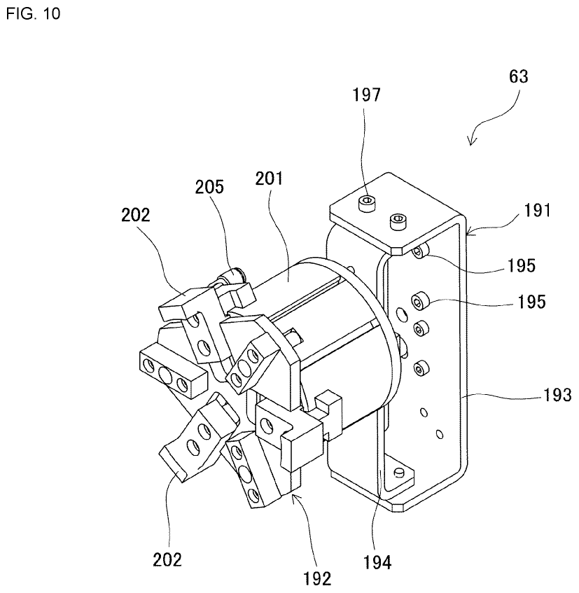

Next, workpiece conveyance device 13 will be described. In workpiece conveyance device 13 of the present embodiment, first and second reversing units 61 and 62 can be replaced with shift unit 63 (see FIGS. 9 and 10). When first and second reversing units 61 and 62 are attached, workpiece conveyance device 13 reverses and delivers workpiece W between first and second machine tools 11 and 12. The reversal of workpiece W means, for example, when workpiece W is attached to the spindle device, rotating workpiece W by 180 degrees so as to switch the portion on the proximal end side and the portion on the distal end side in the direction along the spindle of the spindle device, and to deliver workpiece W. When shift unit 63 is attached, workpiece conveyance device 13 delivers workpiece W between first and second machine tools 11 and 12 while maintaining the posture of workpiece W without reversing workpiece W. Maintaining of the posture of workpiece W means that workpiece W is delivered between first and second machine tools 11 and 12 without switching the posture of workpiece W in the direction along the spindle, contrary to the above-described reversal. FIGS. 1 and 3 illustrate a state where first and second reversing units 61 and 62 are attached to workpiece conveyance device 13.

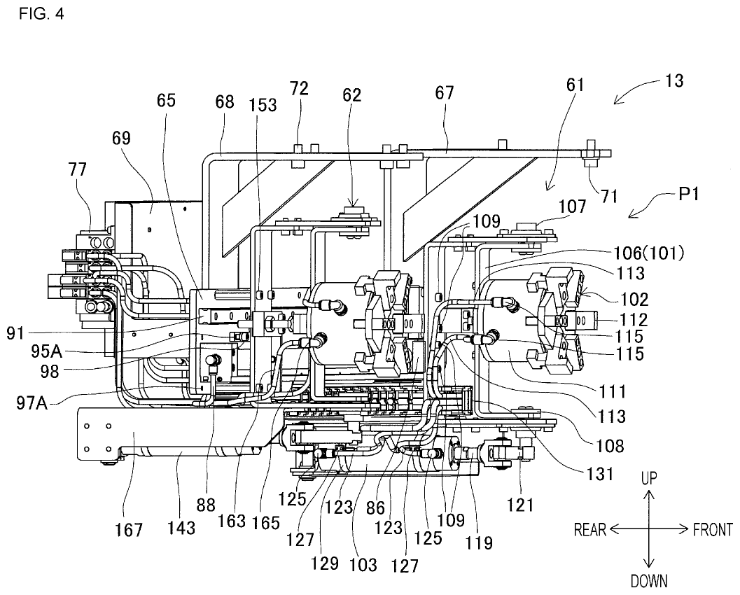

As illustrated in FIGS. 4 to 6, workpiece conveyance device 13 includes main body frame portion 65, first support member 67, second support member 68, and third support member 69. Main body frame portion 65 is a substantially rectangular metal plate member having a predetermined width in the up-down direction and being long in the left-right direction. First and second support members 67 and 68 have substantially the same shape, and are, for example, members obtained by bending a rectangular steel material into an L shape. First support member 67 is attached to a right end portion of main body frame portion 65 in the left-right direction, and second support member 68 is attached to a left end portion of main body frame portion 65 in the left-right direction.

An upper portion of first support member 67 is bent forward and fixed to the left end portion of rail base 41 of second machine tool 12 by multiple fastening members 71 (see FIG. 1). Fastening member 71 is, for example, a bolt or a nut. Fastening member 71 is not limited to a bolt or a nut, and may be a screw or a clamp member. First support member 67 may be fixed to rail base 41 by welding. In addition, similar to fastening member 71, a bolt or a nut and a screw or a clamp member may be adopted for another fastening member to be described later.

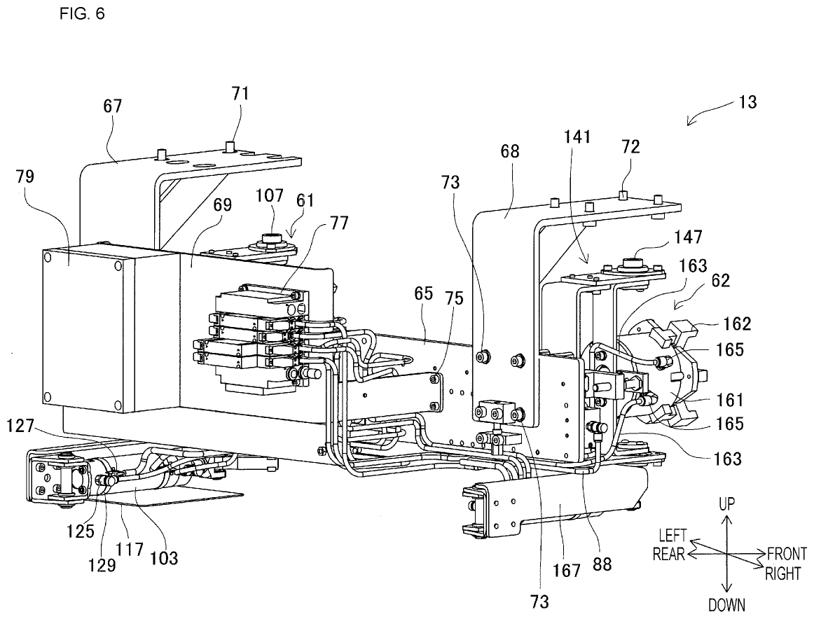

Similarly, an upper portion of second support member 68 is bent forward and fixed to the right end portion of rail base 51 of first machine tool 11 by multiple fastening members 72 (see FIG. 1). The lower portions of first and second support members 67 and 68 face forward, and are fixed to each of end portions of main body frame portion 65 in the left-right direction by fastening members 73 (see FIG. 6). Accordingly, workpiece conveyance device 13 is fixed to first and second machine tools 11 and 12 by first and second support members 67 and 68, and is held in a state of being separated upward from the set surface. The method of installing workpiece conveyance device 13 is not limited to the above-described method. For example, workpiece conveyance device 13 may include only one of first and second support members 67 and 68. Workpiece conveyance device 13 may include a self-supporting column member or the like without being fixed to first and second machine tools 11 and 12.

Third support member 69 is a plate-shaped metal member, and is fixed to the rear of main body frame portion 65 by multiple fastening members 75 (see FIG. 6). Multiple solenoid valves 77 and processing box 79 are attached to the rear surface of third support member 69. Multiple solenoid valves 77 execute switching of air to be supplied to each of later-described rod-less cylinder 83, air cylinders 103 and 143 of first and second reversing units 61 and 62, and first and second clamping sections 102 and 142. Air of a desired pressure is supplied from air supply device 15 (see FIG. 2) of first machine tool 11 to solenoid valve 77, and the supply amount of air supplied to rod-less cylinder 83 or the like is changed based on the control of first control section 25. That is, first control section 25 can control the operation of rod-less cylinder 83 and the like. Signal processing board 81 (see FIG. 2) is provided in processing box 79. Signal processing board 81 is connected to proximity sensor 89 and cylinder switches 127 and 179, which will be described later, receives the signal output from proximity sensor 89 or the like, and outputs the signal to first control section 25. In FIGS. 4 to 6, illustration of a part of a signal cable connecting each device and signal processing board 81 of processing box 79 is omitted in order to avoid complication of the drawing.

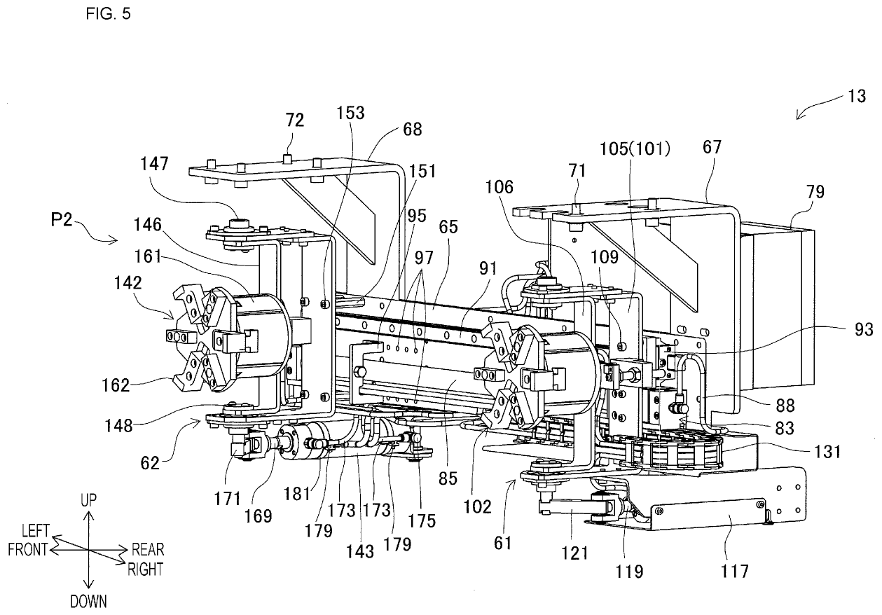

Rod-less cylinder 83 (see FIG. 5) is attached to the front surface of main body frame portion 65. Rod-less cylinder 83 includes cylinder main body 85 (see FIG. 5) and first table 86 (see FIG. 4). Cylinder main body 85 has, for example, a cylindrical shape with a cavity inside, is disposed from the left end portion to the right end portion of main body frame portion 65, and is fixed to main body frame portion 65 with the axial direction along the left-right direction. Cylinder main body 85 is connected to solenoid valve 77 via air pipe 88 connected to each of the right side surface and the left side surface. Air pipe 88 is connected to cylinder main body 85 via, for example, a so-called one touch joint. First control section 25 causes air supply device 15 and solenoid valve 77 to change the direction and the supply amount of the air supplied into cylinder main body 85. First table 86 is coupled to a piston (not illustrated) inserted into cylinder main body 85, and moves in the left-right direction according to the supply direction and the supply amount of air supplied from air supply device 15 (see FIG. 2) to cylinder main body 85.

Rod-less cylinder 83 is provided with proximity sensor 89 (see FIG. 3) that detects whether first table 86 approaches the left end portion side of cylinder main body 85. The configuration of proximity sensor 89 is not particularly limited, and can adopt, for example, a magnet provided on a piston in cylinder main body 85 and a magnetic sensor capable of detecting the position of the magnet. Proximity sensor 89 is not limited to a magnetic sensor, and may be another type of sensor such as an infrared sensor. Proximity sensor 89 outputs a signal corresponding to first table 86 approaching the left end portion of cylinder main body 85 to first control section 25. Thus, first control section 25 can detect whether leftward movement of first reversing unit 61 and shift unit 63, which will be described later, has been completed. Accordingly, in proximity sensor 89, the position and sensitivity of the sensor are adjusted so as to output a signal indicating the approach in accordance with the movement of first table 86 to a movement destination position (a position where first table 86 is stopped by stopper 95 described later) where first reversing unit 61 and shift unit 63 are stopped.

Rail member 91 is provided on the front surface of main body frame portion 65 and above rod-less cylinder 83. Rail member 91 is, for example, a plate-shaped member elongated in the left-right direction, and is fixed to main body frame portion 65 in parallel to cylinder main body 85. Second table 93 is attached to rail member 91. Second table 93 is slidably attached to rail member 91. Second table 93 is fixed to first table 86, for example, and moves integrally with first table 86 as first table 86 slides. Second table 93 need not be fixed to first table 86. Grease nipple 93A (see FIG. 11) for introducing grease to reduce frictional resistance between second table 93 and rail member 91 is attached to second table 93.

As illustrated in FIG. 5, multiple stopper holes 97 for attaching stopper 95 are formed in the front surface of main body frame portion 65. Stopper hole 97 is, for example, a through hole penetrating main body frame portion 65 in the front-rear direction. As multiple stopper holes 97, for example, multiple pairs of stopper holes 97 are formed at predetermined intervals along the left-right direction at positions sandwiching cylinder main body 85 in the up-down direction.

For example, stopper 95 is formed by bending a plate-shaped metal member having a predetermined width into a gate shape, and attached to main body frame portion 65 so as to straddle the front side of cylinder main body 85 in the up-down direction in a state of being attached to main body frame portion 65. In stopper 95, an upper end portion and a lower end portion are bent to the left. The bent end portion on the upper side of stopper 95 is fixed by fastening member 98 (for example, a bolt, see FIG. 4) inserted into upper stopper hole 97 among pair of stopper holes 97 arranged in the up-down direction. In addition, the bent end portion on the lower side of stopper 95 is fixed by fastening member 98 inserted into lower stopper hole 97 among pair of stopper holes 97 arranged in the up-down direction. Accordingly, the position of stopper 95 in the left-right direction is adjusted by being fixed to any set of stopper holes 97 of multiple sets of stopper holes 97 arranged in the left-right direction.

Stopper 95 is a member for restricting leftward movement of first table 86 to which first reversing unit 61 and shift unit 63 are attached at a predetermined stop position. In the case of first reversing unit 61, the predetermined stop position is a position at which first reversing unit 61 delivers workpiece W to second reversing unit 62 and is a position corresponding to the width (length in axial direction) of the delivered workpiece W or the like. When first reversing unit 61 is attached, stopper 95 is attached to stopper hole 97 of any set and abuts on first table 86 to stop first reversing unit 61 at a predetermined stop position. For example, before attaching and using first and second reversing units 61 and 62, the user experimentally moves first reversing unit 61 to second reversing unit 62 side to adjust the position of stopper 95. The specific position to be adjusted will be described later. In addition to stopper hole 97, pair of stopper holes 97A (see FIG. 4) is formed in a left end portion of main body frame portion 65. Stopper hole 97A is used when shift unit 63 is attached. In the case of shift unit 63, the predetermined stop position is a position at which shift unit 63 delivers workpiece W to first loader 22. The user attaches stopper 95 to stopper hole 97A in accordance with the use of shift unit 63. Therefore, the approaching position detected by proximity sensor 89 is a position at which first table 86 can be stopped by stopper 95 when stopper 95 is attached to one of stopper holes 97 and 97A.

Insertion hole 95A (see FIG. 4) is formed in each of the bent end portions on the upper side and the lower side of stopper 95. Insertion hole 95A is an insertion hole into which fastening member 98 is inserted. Insertion hole 95A is, for example, a long hole elongated in the left-right direction, and inserted fastening member 98 is slidable in the left-right direction. Therefore, the position of stopper 95 in the left-right direction can be adjusted in a state where fastening member 98 inserted into stopper holes 97 and 97A is inserted into insertion hole 95A. Therefore, for example, in the position adjustment of stopper 95, the user can adjust the position at which first table 86 (first reversing unit 61) is stopped by adjusting not only the position of stopper hole 97 to which stopper 95 is attached, but also the position (the position at which fastening member 98 is fastened) at which stopper 95 is attached to fastening member 98.

### (First Reversing Unit 61)

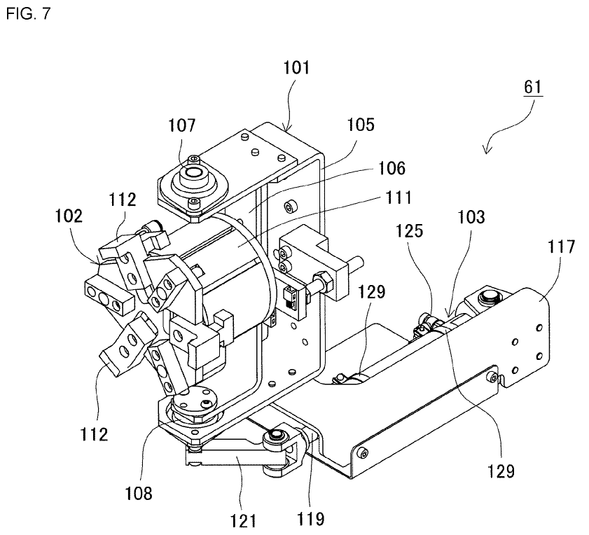

FIG. 7 is a perspective view of first reversing unit 61, and illustrates a state where first reversing unit 61 is removed from workpiece conveyance device 13. As illustrated in FIGS. 4 to 7, first reversing unit 61 includes first link mechanism 101, first clamping section 102, and air cylinder 103. First link mechanism 101 includes first link member 105, second link member 106, and bearing members 107 and 108. First link member 105 has, for example, a shape obtained by bending each of both ends of a plate-shaped metal member along the up-down direction by 90 degrees to the front side, and has a substantially C shape when viewed from the left-right direction.

Portions of first link member 105 along the up-down direction are fixed to first and second tables 86 and 93 by multiple (four in the present embodiment) fastening members 109 arranged in the up-down direction. For example, upper two fastening members 109 are fixed to second table 93, and lower two fastening members 109 are fixed to first table 86. Accordingly, first reversing unit 61 moves in the left-right direction along with the movement of first and second tables 86 and 93, that is, the driving of rod-less cylinder 83. Further, the user can remove first reversing unit 61 from workpiece conveyance device 13 by removing four fastening members 109. First and second tables 86 and 93 are an example of a first attachment section of the present disclosure. The drive source for moving first reversing unit 61 is not limited to rod-less cylinder 83, and may be a linear motor or an actuator.

Second link member 106 is formed, for example, by bending each of both ends of a plate-shaped metal member having a width smaller than that of first link member 105 by 90 degrees to the front side, and has a substantially C shape when viewed from the left-right direction in the state illustrated in FIG. 7. An upper end portion of second link member 106 bent forward is attached to first link member 105 via bearing member 107, and a lower end portion thereof bent forward is attached to first link member 105 via bearing member 108. Bearing members 107 and 108 include bearings, for example, and support second link member 106 rotatably in the left-right direction with respect to first link member 105. Second link member 106 is rotatable about a rotation axis along the up-down direction.

First clamping section 102 is fixed to a portion of second link member 106 along the up-down direction. First clamping section 102 includes clamping main body portion 111 and multiple clamping claws 112. Clamping main body portion 111 has a substantially cylindrical shape. Two air pipes 113 are connected to clamping main body portion 111. Two air pipes 113 are connected to air supply device 15 via solenoid valve 77. Multiple clamping claws 112 are attached to the front surface of clamping main body portion 111, are provided at intervals of 120 degrees, and thus, total three clamping claws 112 are attached. Three clamping claws 112 are attached so as to be movable along the radial direction of cylindrical clamping main body portion 111. Clamping main body portion 111 has a cylinder or the like therein, and moves three clamping claws 112 in the radial direction according to the direction and the supply amount of the air supplied from air supply device 15. Accordingly, first clamping section 102 clamps and holds workpiece W (see FIG. 11), or releases the clamping of workpiece W.

Each of two air pipes 113 is connected to clamping main body portion 111 via joint 115. Each of two joints 115 is a so-called one touch joint (which may also be referred to as a push button type joint), is connected by pushing in air pipe 113, and air pipe 113 can be easily removed by pushing in a slide member provided in an opening portion. Accordingly, when removing first reversing unit 61, the user can easily remove two air pipes 113 from clamping main body portion 111 by operating joint 115.

Air cylinder 103 is attached below first link mechanism 101. Air cylinder 103 is fixed to cover member 117 attached to the lower surface of first link member 105. The distal end of output rod 119 of air cylinder 103 is coupled to second link member 106 via coupling member 121. Accordingly, first clamping section 102 rotates together with second link member 106 according to the position of output rod 119. When output rod 119 is fully retracted to the proximal end side (rear side), first clamping section 102 of the present embodiment is at a rotation position (hereinafter, referred to as a front rotation position) facing the front surface illustrated in FIG. 4. In a state where first clamping section 102 is at the front rotation position and first reversing unit 61 is disposed at first position P1, first clamping section 102 delivers workpiece W between second loader 32 and first clamping section 102. When output rod 119 is completely pushed out to the distal end side (front side), first clamping section 102 is at a rotation position (hereinafter, referred to as a leftward rotation position) facing the left side illustrated in FIG. 11. Accordingly, first clamping section 102 rotates 90 degrees between the front rotation position and the leftward rotation position according to the driving of air cylinder 103. In a state where first clamping section 102 is at the leftward rotation position and first reversing unit 61 is close to second reversing unit 62, first clamping section 102 delivers workpiece W between second reversing unit 62 and first clamping section 102.

Two air pipes 123 (see FIG. 4) are connected to air cylinder 103 via joint 125 (for example, one touch joint). Air cylinder 103 is supplied with air from air supply device 15 via air pipe 123 and solenoid valve 77, and moves output rod 119 in the front-rear direction. Accordingly, first control section 25 can change the orientation of first clamping section 102, that is, the orientation of first reversing unit 61 to the front rotation position or the leftward rotation position by controlling air supply device 15 and the like. When removing first reversing unit 61, the user can easily remove air pipe 123 from air cylinder 103 by operating joint 125.

Air cylinder 103 is an example of a first rotation drive section of the present disclosure. The drive source for rotating first clamping section 102 is not limited to air cylinder 103, and may be a hydraulic cylinder, a motor, an actuator, or the like. First reversing unit 61 is not limited to a configuration in which first reversing unit 61 is rotated and stopped at two rotation positions of the front rotation position and the leftward rotation position, and may be configured to stop first clamping section 102 at three or more rotation positions. That is, control may be performed to stop first clamping section 102 at a finer rotation position by air cylinder 103. The rotation range of first clamping section 102 is not limited to 90 degrees, and may be other angles such as 60 degrees and 180 degrees. That is, the rotation position at which workpiece W is delivered to second reversing unit 62 and the rotation position at which workpiece W is delivered to second loader 32 are not limited to the relationship of 90 degrees.

Two cylinder switches 127 for detecting the position of output rod 119 are attached to air cylinder 103. Each of two cylinder switches 127 is attached to both ends of an air cylinder 103 extending in the front-rear direction, and is configured to be able to detect output rod 119 at the above-described front rotation position (position at which air cylinder 103 is completely returned) and output rod 119 at the leftward rotation position (position at which air cylinder 103 is completely pulled out). Cylinder switch 127 includes, for example, a magnetoresistive element that detects a change in magnetic field caused by a magnet attached to a piston of air cylinder 103, and outputs a signal corresponding to approach of the magnet, that is, a position of output rod 119, to signal processing board 81. Accordingly, first control section 25 can detect that first clamping section 102 has rotated to the front rotation position or the leftward rotation position based on the signal of cylinder switch 127. The method of detecting the rotation position of first clamping section 102 is not limited to the method using cylinder switch 127, and may be, for example, a method using a contact switch that comes into contact with rotating first clamping section 102 or the like, or a method using an encoder that outputs position information of the rotation position of first clamping section 102.

Two cylinder switches 127 are fixed by, for example, metal band 129 wound around air cylinder 103. Metal band 129 is fixed to air cylinder 103 by fastening screws to both ends thereof in a state where cylinder switch 127 is sandwiched between both ends thereof. Therefore, when removing first reversing unit 61, the user can remove cylinder switch 127 from first reversing unit 61 by loosening the screw.

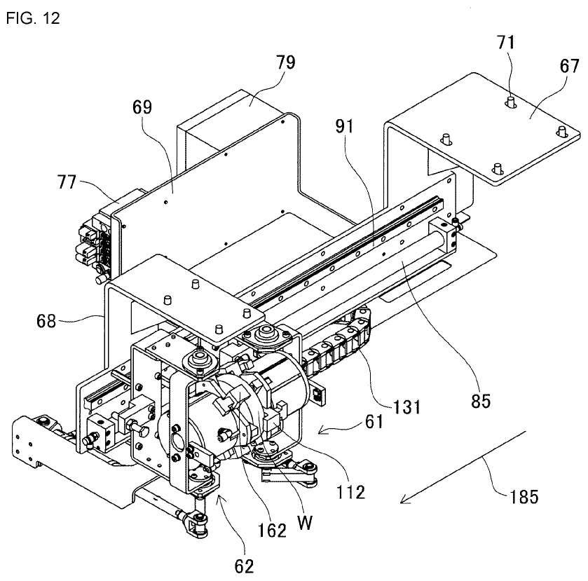

As illustrated in FIGS. 4 and 5, cableveyor 131 capable of accommodating the signal cables of air pipes 113 and 123 and cylinder switch 127 is attached to workpiece conveyance device 13. Cableveyor 131 accommodates and protects air pipe 123 and the like which are bent according to the sliding movement of first reversing unit 61 (see FIG. 12). When first reversing unit 61 is removed, in a state where air pipes 113 and 123 and cylinder switch 127 are attached to first reversing unit 61 without being removed from first reversing unit 61, air pipe 113 or the like may be removed from workpiece conveyance device 13. For example, a proximal end portion of air pipe 113 may be removed from solenoid valve 77.

### (Second Reversing Unit 62)

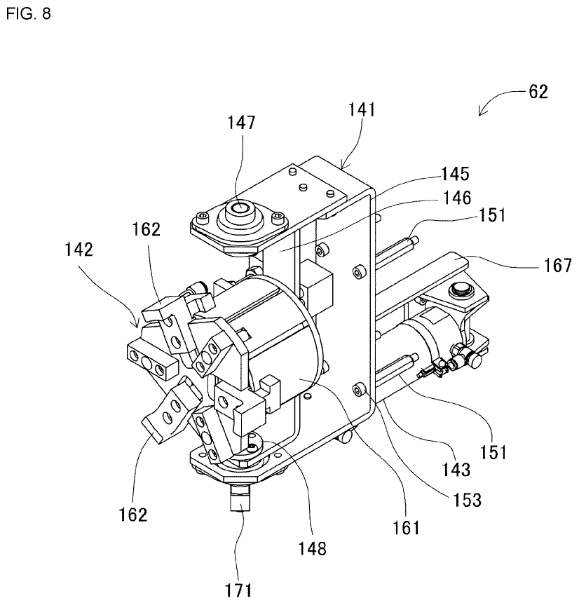

Next, second reversing unit 62 will be described. In the following description of second reversing unit 62, description of the same configuration as that of first reversing unit 61 will be appropriately omitted. FIG. 8 is a perspective view of second reversing unit 62, and illustrates a state where second reversing unit 62 is removed from workpiece conveyance device 13. FIG. 8 illustrates a state in which spacer 151 described later is attached to second reversing unit 62. As illustrated in FIGS. 4 to 6 and 8, second reversing unit 62 includes second link mechanism 141, second clamping section 142, and air cylinder 143, similarly to first reversing unit 61. Second link mechanism 141 includes substantially C-shaped first and second link members 145 and 146, and bearing members 147 and 148.

A portion of first link member 145 along the up-down direction is fixed to main body frame portion 65 via multiple (four in the present embodiment) spacers 151. Spacer 151 is, for example, a hexagonal spacer, and a screw hole (not illustrated) into which screw 153 is screwed is formed in a front end thereof. Each of four spacers 151 is fixed to first link member 145 by screw 153 screwed from the front surface of first link member 145. Tapped holes 65A (see FIG. 9) are formed in main body frame portion 65 in accordance with the positions of four spacers 151. Each of four tapped holes 65A has, for example, a female screw portion formed on an inner peripheral surface of the hole, and is formed to penetrate main body frame portion 65 along the front-rear direction. A male screw portion is formed at the rear end of each of four spacers 151. Each of four spacers 151 is fixed to main body frame portion 65 by screwing the male screw portion at the rear end into tapped hole 65A. Accordingly, first link member 145 is fixed to rail member 91 and cylinder main body 85 by four spacers 151 at positions separated by a predetermined distance to the front side. The user can adjust the position of first link member 145 in the front-rear direction, that is, the position of second reversing unit 62 by adjusting the position at which spacer 151 is screwed into tapped hole 65A. The user can adjust the position of second reversing unit 62 in the front-rear direction with respect to first reversing unit 61 and the position of first and second reversing units 61 and 62 when first and second reversing units 61 and 62 face each other and deliver workpiece W by adjusting the position (amount of screwing) of spacer 151. When removing second reversing unit 62 from workpiece conveyance device 13, the user can remove second reversing unit 62 from main body frame portion 65 by loosening screw 153. Further, each of spacers 151 can be removed from main body frame portion 65 by loosening the male screw portion at the rear end with respect to tapped hole 65A. The portion of main body frame portion 65 where tapped hole 65A for inserting spacer 151 is formed is an example of a second attachment section of the present disclosure. The method of fixing second reversing unit 62 to main body frame portion 65 is not limited to the method using spacer 151 (hexagonal spacer), and may be a method using a bolt or a nut.

Second link member 146 is accommodated on the front side of first link member 145, and is rotatably attached to first link member 145 via upper bearing member 147 and lower bearing member 148. Second link member 146 is rotatable about a rotation axis along the up-down direction. Second clamping section 142 is fixed to second link member 146, and includes clamping main body portion 161 and three clamping claws 162. Clamping main body portion 161 is connected to solenoid valve 77 via two air pipes 163. Three clamping claws 162 are attached to the front surface of clamping main body portion 161, and clamps workpiece W in accordance with the direction and the supply amount of the air supplied from air supply device 15 to clamping main body portion 161 via solenoid valve 77.

Further, each of two air pipes 163 is connected to clamping main body portion 161 via so-called one touch joint 165. Accordingly, when removing second reversing unit 62, the user can easily remove two air pipes 163 from clamping main body portion 161 by operating joint 165.

Air cylinder 143 is provided below second link mechanism 141, and is fixed to cover member 167 attached to the lower surface of first link member 145. The distal end of output rod 169 of air cylinder 143 is coupled to second link member 146 via coupling member 171. When output rod 169 is retracted to the proximal end side, second clamping section 142 is at a front rotation position facing the front surface as illustrated in FIG. 4, and delivers workpiece W between first loader 22 and output rod 169 at second position P2 (see FIG. 1). When output rod 169 is pushed out to the distal end side, second clamping section 142 is at a rotation position (hereinafter, referred to as a rightward rotation position) facing the right side illustrated in FIG. 11. Accordingly, second clamping section 142 rotates 90 degrees between the front rotation position and the rightward rotation position according to the driving of air cylinder 143. At the rightward rotation position, second clamping section 142 delivers workpiece W between first reversing unit 61 and second clamping section 142.

In air cylinder 143, similarly to air cylinder 103, two air pipes 173 (see FIG. 5) are connected via joint 175 (for example, a one touch joint). Air cylinder 143 is supplied with air from air supply device 15 via air pipe 173 and solenoid valve 77, and moves output rod 169 in the front-rear direction. Accordingly, first control section 25 can change the orientation of second clamping section 142 by controlling air supply device 15 and the like. In addition, when removing second reversing unit 62, the user can easily remove air pipe 173 from air cylinder 143 by operating joint 175. Air cylinder 143 is an example of a second rotation drive section of the present disclosure.

Similarly to air cylinder 103, two cylinder switches 179 for detecting the position of output rod 169 are attached to air cylinder 143 by metal band 181. Cylinder switch 179 outputs a signal corresponding to the position of output rod 169 to signal processing board 81. Accordingly, first control section 25 can detect that second clamping section 142 has rotated to the front rotation position or the rightward rotation position based on the signal of cylinder switch 179. When removing second reversing unit 62, the user can remove cylinder switch 179 from second reversing unit 62 by loosening the screw of metal band 181.

### (Shift Unit 63)

Next, shift unit 63 will be described. As described above, first and second reversing units 61 and 62 are attachable to and detachable from workpiece conveyance device 13. Shift unit 63 can be attached to workpiece conveyance device 13 instead of first reversing unit 61. FIG. 9 is a perspective view of workpiece conveyance device 13 to which shift unit 63 is attached. FIG. 10 is a perspective view of shift unit 63, and illustrates a state where shift unit 63 is removed from workpiece conveyance device 13. In the following description, description of the same contents as those of the description of first and second reversing units 61 and 62 will be appropriately omitted.

As illustrated in FIGS. 9 and 10, shift unit 63 includes support member 191 and clamping section 192. Support member 191 includes first support member 193 and second support member 194. First support member 193 is formed, for example, by bending each of both ends of a plate-shaped metal member elongated in the up-down direction by 90 degrees toward the front side. Portions of first support member 193 along the up-down direction are fixed to first and second tables 86 and 93 (see FIG. 11) by four fastening members 195 arranged in the up-down direction. Fastening member 195 may be the same member as fastening member 109 that fixes first reversing unit 61.

Similarly to first reversing unit 61, shift unit 63 moves in the left-right direction along with the movement of first and second tables 86 and 93, that is, the driving of rod-less cylinder 83. The user can remove shift unit 63 from workpiece conveyance device 13 by removing four fastening members 195. That is, shift unit 63 and first reversing unit 61 can be replaced.

Second support member 194 is formed by bending each of both ends of a plate-shaped metal member elongated in the up-down direction rearward, and is disposed inside first support member 193. Both ends of second support member 194 in the up-down direction are fixed to first support member 193 by multiple fastening members 197. Clamping section 192 is fixed to a portion of second support member 194 along the up-down direction. Accordingly, the relative position of clamping section 192 with respect to rod-less cylinder 83 is fixed.

Similarly to first clamping section 102, clamping section 192 includes clamping main body portion 201 and three clamping claws 202. Clamping main body portion 201 is connected to solenoid valve 77 via two air pipes 113 (see FIG. 9), and drives three clamping claws 112 according to the pressure of air supplied from air supply device 15 or the like. Accordingly, clamping section 192 clamps and holds workpiece W or releases the clamping of workpiece W. First reversing unit 61 and shift unit 63 are configured to be able to share air pipe 113 for driving the clamping section. Further, each of two air pipes 113 is connected to clamping main body portion 201 via one touch joint 205 (see FIG. 10). Accordingly, even when removing shift unit 63, the user can easily remove two air pipes 113 from clamping main body portion 201 by operating joint 205. Air pipe 113 connected to first reversing unit 61 and air pipe 113 connected to shift unit 63 may be separate pipes.

Since shift unit 63 does not rotate unlike first reversing unit 61, air cylinder 103 and cylinder switch 127 are not provided. Therefore, when shift unit 63 is attached, air pipe 123 connected to air cylinder 103 and the signal cable of cylinder switch 127 become unnecessary. Although not illustrated in FIG. 9, the cable may be retracted to the proximal end side (solenoid valve 77 side) of cableveyor 131 and accommodated therein, or may be disposed in a state in which the distal end of the cable is not connected near shift unit 63 while being inserted into cableveyor 131.

When shift unit 63 is used, second reversing unit 62 is removed from workpiece conveyance device 13. Stopper 95 is removed from stopper hole 97, for example, and is attached to stopper hole 97A of the left end portion of main body frame portion 65. Shift unit 63 delivers workpiece W between second loader 32 and shift unit 63 at a position illustrated in FIG. 9, that is, first position P1 illustrated in FIG. 1. Shift unit 63 is moved to a position where first table 86 abuts on stopper 95, that is, second position P2 (see FIG. 1), based on the control of first control section 25. At second position P2, shift unit 63 delivers workpiece W between first loader 22 and shift unit 63. Accordingly, shift unit 63 delivers workpiece W received from a first one of first and second loaders 22 and 33 to a second one while maintaining the posture of workpiece W.

Accordingly, workpiece conveyance device 13 of the present embodiment includes first table 86 to which only one of first reversing unit 61 and shift unit 63 can be attached, and tapped hole 65A to which second reversing unit 62 can be attached and detached. When the machining process using machine tool 10 is changed, there is a case where workpiece W is desired to be reversed and delivered from first machine tool 11 to second machine tool 12 or vice versa, or a case where workpiece W is desired to be delivered in a state of maintaining the posture without being reversed. In such a case, with the above-described configuration, it is not necessary to replace the entire workpiece conveyance device 13, and only by replacing the unit, it is possible to cope with the reversal and the shift by one workpiece conveyance device 13. In addition, in the case of replacement on a unit-by-unit basis, a smaller number of users, for example, a single user can replace the unit. As a result, the user can quickly switch the reversal process and the shift process.

(Reversing Control when First and Second Reversing Units 61 and 62 are Attached)

Next, the reversing control for reversing and delivering workpiece W when first and second reversing units 61 and 62 are attached to workpiece conveyance device 13 will be described. As an example, a case where workpiece W is delivered from second machine tool 12 to first machine tool 11 will be described. For example, second control section 35 of second machine tool 12 executes control of delivering workpiece W subjected to predetermined machining by second machining section 31 from the spindle device of second machining section 31 to chuck mechanism 47 of second loader 32. Second control section 35 moves chuck mechanism 47 clamping workpiece W to first position P1 (see FIGS. 1 and 4), that is, the position of first reversing unit 61.

First control section 25 of first machine tool 11 controls first reversing unit 61 of workpiece conveyance device 13 such that first clamping section 102 is caused to clamp workpiece W clamped by chuck mechanism 47 of second loader 32. For example, in an initial state in which the work by first reversing unit 61 is not executed, first control section 25 arranges first reversing unit 61 at first position P1 at the front rotation position. For example, when first control section 25 acquires, from second control section 35, a notification indicating that second loader 32 is disposed at the position of first reversing unit 61, first control section 25 causes first clamping section 102 to clamp workpiece W on second loader 32. The method of notifying that second loader 32 has been disposed is not particularly limited, and for example, first and second machine tools 11 and 12 may be connected to each other by a wire such as a LAN cable, and the timing of the delivery of workpiece W may be notified between first and second control sections 25 and 35 such as second loader 32 being disposed. For example, when the completion of the clamping of workpiece W by first clamping section 102 is detected by a sensor (not illustrated) or the like provided in first clamping section 102, first control section 25 notifies second control section 35 of the completion. Upon acquiring the completion notification from first control section 25, second control section 35 releases the clamping of workpiece W by chuck mechanism 47. Thus, workpiece W can be delivered from second loader 32 to first reversing unit 61. Notification and a control method of timing of the delivery of workpiece W described above is an example. For example, first and second control sections 25 and 35 may detect timing of starting the clamping of workpiece W, timing of releasing the clamping of workpiece W, and the like by sensors attached to second loader 32 and first reversing unit 61.

When the clamping by first clamping section 102 is completed, first control section 25 causes air cylinder 103 to rotate first clamping section 102 clamping workpiece W in the left direction by 90 degrees as indicated by arrow 183 in FIG. 11 and rotate first clamping section 102 to the leftward rotation position. That is, first control section 25 rotates first reversing unit 61 at first position P1. First control section 25 may rotate first reversing unit 61 while or after approaching second reversing unit 62.

As illustrated in FIG. 11, first control section 25 also rotates second reversing unit 62 simultaneously with the rotation of first reversing unit 61. First control section 25 causes air cylinder 143 of second reversing unit 62 to rotate second clamping section 142 by 90 degrees in the right direction as indicated by arrow 184 in FIG. 11 and rotate second clamping section 142 to the rightward rotation position. In FIG. 11 and FIG. 12 described later, illustration of air pipe 113, a signal cable of cylinder switch 127, and the like is omitted in order to avoid complication of the drawing.

Accordingly, in the reversing control, first control section 25 of the present embodiment receives workpiece W from second loader 32 to first reversing unit 61, and then rotates second reversing unit 62 so as to face first reversing unit 61 in the left-right direction in accordance with the rotation of first reversing unit 61 in a state of holding received workpiece W. Then, as will be described later, first control section 25 executes control for delivering workpiece W from rotated first reversing unit 61 to second reversing unit 62.

In such a configuration, the number of solenoid valves 77 for controlling first and second reversing units 61 and 62 can be reduced. Specifically, for example, air cylinder 103 of first reversing unit 61 and air cylinder 143 of second reversing unit 62 of the present embodiment are connected to the same solenoid valve 77. An advance/retreat position of output rod 169 of air cylinder 143 is controlled to the same position as (synchronized with) an advance/retreat position of output rod 119 of air cylinder 103. Accordingly, when first reversing unit 61 is at the front rotation position, second reversing unit 62 is also at the front rotation position, and when first reversing unit 61 is at the leftward rotation position, second reversing unit 62 is at the rightward rotation position. This can reduce the number of solenoid valves 77 necessary for controlling air cylinders 103 and 143. Further, the contents of the control processing of air cylinders 103 and 143 by first control section 25 can be simplified. Air cylinders 103 and 143 may be connected to different solenoid valves 77.

When first control section 25 detects that first reversing unit 61 has rotated to the leftward rotation position based on the signal of cylinder switch 127, first control section 25 causes rod-less cylinder 83 to move first reversing unit 61 clamping workpiece W leftward. As indicated by arrow 185 in FIG. 12, first reversing unit 61 moves toward second reversing unit 62 to a position close to second reversing unit 62. By executing the rotation control and the movement control in a stepwise manner in this manner, the control content by first control section 25 can be simplified. For example, first control section 25 causes rod-less cylinder 83 at a predetermined air pressure to move first reversing unit 61 leftward. This predetermined air pressure is the same pressure as the shift control of shift unit 63 described later. First reversing unit 61 stops when the leftward movement of first table 86 (see FIG. 11) is restricted by stopper 95. In other words, the user can adjust the stop position of first reversing unit 61 by changing the position (position fixed by stopper hole 97 or fastening member 98 to be fastened) of stopper 95 in the left-right direction. As a result, the distance between first and second reversing units 61 and 62 when workpiece W is delivered can be adjusted to a distance matching the width of workpiece W. For example, the user can fix stopper 95 at an appropriate position by operating first operation section 23, moving first reversing unit 61 clamping workpiece W to the position of second reversing unit 62, and adjusting the position of stopper 95 while checking whether first and second reversing units 61 and 62 can appropriately deliver workpiece W.

Further, as will be described later, by controlling rod-less cylinder 83 with the same pressure in the reversing control and the shift control, it is not necessary to replace rod-less cylinder 83 or solenoid valve 77 in accordance with the replacement of first and second reversing units 61 and 62 and shift unit 63. That is, by adjusting the stop position by stopper 95 while controlling at the same pressure, same rod-less cylinder 83 and same solenoid valve 77 can be used regardless of the type of unit. Therefore, it is possible to reduce the load of the replacement work of the unit by the user. First control section 25 may control rod-less cylinder 83 with different pressures in the reversing control and the shift control described later. Further, workpiece conveyance device 13 may be configured to replace rod-less cylinder 83 or solenoid valve 77 every time the unit is replaced.

First control section 25 delivers workpiece W from first reversing unit 61 to second reversing unit 62 in a state where the sliding movement of first reversing unit 61 is restricted by stopper 95. Accordingly, by biasing first reversing unit 61 to the left side by rod-less cylinder 83 and restricting the movement by stopper 95, workpiece W can be delivered while the position of first reversing unit 61 is fixed.

First control section 25 detects that first reversing unit 61 has moved (approached) to a position where first reversing unit 61 is stopped by stopper 95, that is, a position where workpiece W is delivered to the second reversing unit illustrated in FIG. 12, based on a signal of proximity sensor 89 (see FIG. 2). When proximity sensor 89 detects that first reversing unit 61 has moved to the position where the delivery is performed, first control section 25 starts to control second reversing unit 62 to clamp workpiece W. When a sensor or the like detects that second reversing unit 62 has clamped workpiece W, first control section 25 releases the clamping of workpiece W by first reversing unit 61. As a result, proximity sensor 89 can detect that first reversing unit 61 reliably approaches the position where workpiece W is delivered, and the control of the delivery can be started. It is possible to suppress occurrence of an error in delivery of workpiece W.

Workpiece conveyance device 13 need not include proximity sensor 89. For example, first control section 25 may manage the movement of first reversing unit 61 by time and start the delivery of workpiece W to and from second reversing unit 62 after a predetermined time from the start of the movement of first reversing unit 61 in the left direction.

Here, as illustrated in FIGS. 4 and 5, when first and second reversing units 61 and 62 face the front surface, three clamping claws 112 of first reversing unit 61 and three clamping claws 162 of second reversing unit 62 are attached to the same rotation position in the circumferential direction. For example, in the example illustrated in FIGS. 4 and 5, clamping claws 112 and 162 are each attached to the positions of 3 o'clock, 7 o'clock, and 11 o'clock in the clockwise direction at intervals of 120 degrees. Accordingly, as illustrated in FIGS. 11 and 12, when workpiece W is clamped with first and second reversing units 61 and 62 facing each other, each of three clamping claws 112 is at a rotation position shifted from three clamping claws 162 by only 60 degrees in the circumferential direction, and interference with clamping claws 162 is suppressed. As a result, even when the thickness of workpiece W is small, it is possible to appropriately perform the delivery of workpiece W by suppressing the interference of clamping claws 112 and 162.

In other words, in first and second reversing units 61 and 62 of the present embodiment, the positions of clamping claws 112 and 162 are adjusted such that clamping claws 112 and 162 of first and second reversing units 61 and 62 are at the same rotation position in the circumferential direction at the initial position where first and second reversing units 61 and 62 are attached to main body frame portion 65. Accordingly, the user can prevent interference of clamping claws 112 and 162 only by attaching first and second reversing units 61 and 62. The rotation positions of clamping claws 112 and 162 are merely examples. For example, first reversing unit 61 may be configured such that three clamping claws 112 are attached to the positions of 2 o'clock, 6 o'clock, and 10 o'clock when facing the front surface. Alternatively, in a case where workpiece W is relatively thick (long), clamping claws 112 of first reversing unit 61 may be attached at positions of 1 o'clock, 5 o'clock, and 9 o'clock (positions at which the same rotation position is obtained when facing each other). Further, three clamping claws 112 may be attached at different rotation angles.

When workpiece W is delivered from first reversing unit 61 to second reversing unit 62, first control section 25 rotates second reversing unit 62 to the front rotation position. For example, first control section 25 causes rod-less cylinder 83 to return first reversing unit 61 to first position P1, and then causes air cylinders 103 and 143 to simultaneously rotate first and second reversing units 61 and 62 to the front rotation position. Alternatively, first control section 25 may simultaneously rotate first and second reversing units 61 and 62 while returning first reversing unit 61 to first position P1.

After rotating second reversing unit 62 to the front rotation position, first control section 25 delivers workpiece W from second reversing unit 62 to first loader 22. First control section 25 moves first loader 22 to second position P2 and delivers workpiece W from second reversing unit 62 to first loader 22. Thus, workpiece W can be reversed and delivered from second machine tool 12 to first machine tool 11.

Note that first control section 25 can also perform control in the same manner as in the case of delivering workpiece W from second machine tool 12 to first machine tool 11 in the case of delivering workpiece W from first machine tool 11 to second machine tool 12 in a reversed manner. For example, first control section 25 can deliver workpiece W from first machine tool 11 to second machine tool 12 by reversely executing the procedure of the reversing control. In this case, first control section 25 may notify second control section 35 that first reversing unit 61 holding workpiece W is disposed at first position P1 and notify second control section 35 of the control timing of second loader 32.

As described above, first reversing unit 61 of the present embodiment includes first link mechanism 101 that rotatably supports first clamping section 102 and air cylinder 103 that rotates first clamping section 102 supported by first link mechanism 101 (see FIG. 7). Second reversing unit 62 includes second link mechanism 141 that rotatably supports second clamping section 142, and air cylinder 143 that rotates second clamping section 142 supported by second link mechanism 141 (see FIG. 8). According to this, by connecting air pipes 123 and 173 to air cylinders 103 and 143 provided in the respective units, it is possible to cause each unit to perform the rotation operation. There is no need to provide a link mechanism or a rotation drive section on workpiece conveyance device 13 side, and the structure of workpiece conveyance device 13 can be simplified.

First link mechanism 101 is fixed to first table 86 of rod-less cylinder 83 by fastening member 109 (see FIG. 5). Second link mechanism 141 is fixed by screwing spacer 151 into tapped hole 65A (see FIGS. 6 and 9). Air cylinder 103 is connected to air pipe 123 connected to air supply device 15 by joint 125. Air cylinder 143 is connected to air pipe 173 by joint 175. According to this, it is possible to reduce the work burden of removing first and second reversing units 61 and 62 from workpiece conveyance device 13. The user can replace the unit more quickly.

(Shift Control when Shift Unit 63 is Attached)

Next, shift control will be described in which workpiece W is delivered while maintaining the posture (orientation) of workpiece W when shift unit 63 is attached to workpiece conveyance device 13. As an example, a case where workpiece W is delivered from second machine tool 12 to first machine tool 11 will be described. In the following description, description of the same contents as those of the above-described reversing control will be appropriately omitted.

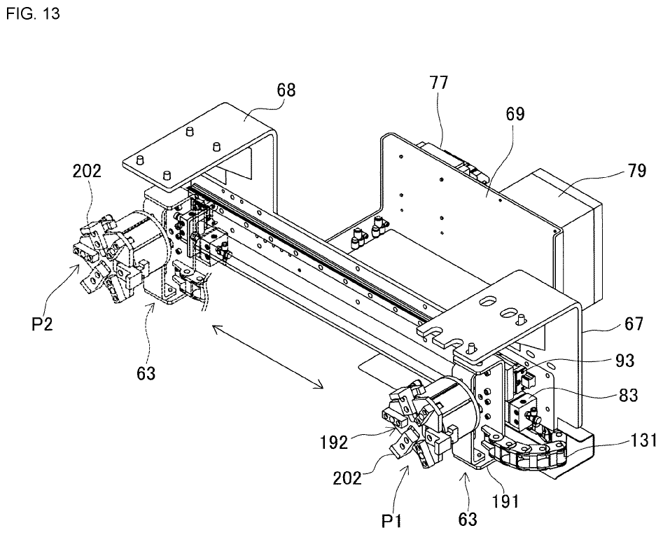

First, second control section 35 of second machine tool 12 moves, for example, second loader 32 receiving workpiece W from second machining section 31 to first position P1 illustrated in FIG. 13. In addition, first control section 25 of first machine tool 11 arranges shift unit 63 at first position P1 and causes workpiece W on second loader 32 to be clamped by clamping section 192 of shift unit 63. When the delivery of workpiece W from second loader 32 to shift unit 63 is completed, first control section 25 causes rod-less cylinder 83 to move shift unit 63 clamping workpiece W to second position P2. First control section 25 causes rod-less cylinder 83 at a predetermined air pressure to move shift unit 63 leftward. The predetermined air pressure is the same pressure as the control pressure of rod-less cylinder 83 in the reversing control. When the shift control is executed, second reversing unit 62 at second position P2 is removed, and rod-less cylinder 83 moves to a position (position indicated by broken line in FIG. 13) where first table 86 abuts on stopper 95 fixed to stopper hole 97A (see FIG. 4). Thus, shift unit 63 is disposed at second position P2. In other words, stopper 95 is attached at a position where shift unit 63 is disposed at second position P2.

When proximity sensor 89 (see FIG. 2) detects that shift unit 63 has moved to second position P2, first control section 25 delivers workpiece W from shift unit 63 to first loader 22. First control section 25 delivers workpiece W from shift unit 63 to first loader 22 in a state where the sliding movement of shift unit 63 is restricted by stopper 95. Accordingly, workpiece W can be delivered from second machine tool 12 to first machine tool 11 while maintaining the posture of workpiece W. First control section 25 can execute the same control as the above-described shift control even when first control section 25 delivers workpiece W from first machine tool 11 to second machine tool 12 while maintaining the posture of workpiece W.

In the above-described reversing control, first reversing unit 61 delivers workpiece W to and from second loader 32 at first position P1. Further, second reversing unit 62 delivers the workpiece to and from first loader 22 at second position P2. In the shift control, shift unit 63 is attached to rod-less cylinder 83 in a state where first and second reversing units 61 and 62 are removed, receives workpiece W from second loader 32 at first position P1, and then moves to the position of second position P2, that is, the position (position of stopper hole 97A or tapped hole 65A) where second reversing unit 62 is removed. As described above, the stroke amount of rod-less cylinder 83 in each control can be adjusted by stopper 95. In such a configuration, the delivery position of workpiece W in the reversing control and the delivery position of workpiece W in the shift control are made common, so that the control contents of first and second loaders 22 and 33 can be made common. For example, first control section 25 can similarly perform the position control of first loader 22 in any of the reversing control and the shift control. In addition, second control section 35 can similarly perform the position control of second loader 32 in any of the reversing control and the shift control. In other words, each control program can be made common.

In the present embodiment, first control section 25 of first machine tool 11 controls the operation of workpiece conveyance device 13. As described above, first operation section 23 and first control section 25 of first machine tool 11 are disposed at positions closer to workpiece conveyance device 13 in the left-right direction than second operation section 33 and second control section 35 of second machine tool 12 (see FIG. 1). In such a configuration, the positions at which first operation section 23 and first control section 25 for controlling workpiece conveyance device 13 are provided can be closer to first position P1 and second position P2 at which workpiece conveyance device 13 delivers workpiece W. In other words, first operation section 23 for controlling workpiece conveyance device 13 is located closer to workpiece conveyance device 13. As a result, the user who operates first operation section 23 can easily see the delivery state of workpiece W, and the efficiency of the checking operation or the like can be improved.

Further, first operation section 23 is disposed on second reversing unit 62 side (second position P2 side) in workpiece conveyance device 13. Therefore, for example, when the position of stopper 95 is adjusted after the replacement with first and second reversing units 61 and 62 or after the type of workpiece W is changed, first operation section 23 can be operated while checking the state of first and second reversing units 61 and 62 restricted by stopper 95 and delivering workpiece W. As a result, the position of stopper 95 can be adjusted more quickly and accurately. Workpiece conveyance device 13 may be controlled by second control section 35 or second operation section 33 of second machine tool 12. Further, workpiece conveyance device 13 may be controlled by both first and second control sections 25 and 35 (first and second operation sections 23 and 33).

Air supply device 15 is an example of a slide mechanism and a fluid driving source. First control section 25 is an example of a control section. Tapped hole 65A is an example of a second attachment section. Rod-less cylinder 83 is an example of a slide mechanism. Cylinder main body 85 is an example of a rail portion. First table 86 is an example of a first attachment section. Stopper hole 97 is an example of a stopper attachment section. Air cylinder 103 is an example of a first rotation drive section. Fastening member 109 is an example of a first fastening member. Air pipe 123 is an example of a first air pipe. Joint 125 is an example of a first one touch joint. Air cylinder 143 is an example of a second rotation drive section. Spacer 151 and screw 153 are examples of a second fastening member. Air pipe 173 is an example of a second air pipe. Joint 175 is an example of a second one touch joint.

As described above, according to the present embodiment described above, the following advantageous effects can be achieved.

In an aspect of the present embodiment, machine tool 10 can convey workpiece W to first machining section 21 by first loader 22, and can convey workpiece W to second machining section 31 by second loader 32. Here, in the configuration including only one loader described in Patent Literature 1, for example, there is a possibility that a waiting time of the loader occurs while the workpiece is reversed by the workpiece reversing device. Meanwhile, in the configuration of the present embodiment, for example, by providing the two loader devices, second loader 32 can execute the work of setting next workpiece W in second machining section 31 on second machine tool 12 side while reversing workpiece W by workpiece conveyance device 13 or conveying reversed workpiece W by first loader 22 to first machining section 21 after delivering workpiece W to workpiece conveyance device 13. Accordingly, workpiece W can be quickly supplied to first and second machining sections 21 and 31 by first and second loaders 22 and 33, and the time required for setting workpiece W can be shortened.

First reversing unit 61, second reversing unit 62, and shift unit 63 can be attached to workpiece conveyance device 13. When first and second reversing units 61 and 62 are attached, first control section 25 causes workpiece conveyance device 13 to execute reversing control for reversing and delivering workpiece W, and when shift unit 63 is attached, first control section 25 executes shift control for delivering workpiece W while maintaining the posture of workpiece W. As a result, both the delivery while maintaining the posture of workpiece W and the reversed delivery can be performed by one workpiece conveyance device 13.

The present disclosure is not limited to the above-described embodiment, and it is needless to say that various improvements and changes can be made without departing from the gist of the present disclosure.

For example, in the above-described embodiment, workpiece conveyance device 13 can attach only one of first and second reversing units 61 and 62 and shift unit 63. In contrast, workpiece conveyance device 13 may be configured such that first and second reversing units 61 and 62 and shift unit 63 can be attached at the same time.

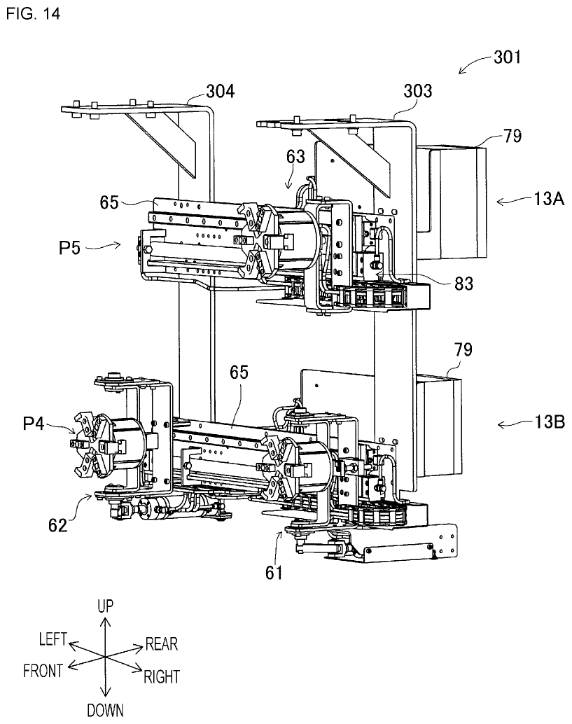

FIG. 14 illustrates workpiece conveyance device 301 of another example. As illustrated in FIG. 14, workpiece conveyance device 301 includes first workpiece conveyance device 13A and second workpiece conveyance device 13B. Workpiece conveyance device 301 is disposed between first and second machine tools 11 and 12 arranged in the left-right direction, for example, similarly to workpiece conveyance device 13 of the above embodiment (see FIG. 1). First and second workpiece conveyance devices 13A and 13B are fixed to first support member 303 and second support member 304, respectively, and are arranged side by side in the up-down direction. First support member 303 has a structure in which the lower end portion of first support member 67 of the above embodiment is extended downward, first workpiece conveyance device 13A is fixed to an upper portion of first support member 303, and second workpiece conveyance device 13B is fixed to an extending lower end portion of first support member 303. Similarly, second support member 304 has a structure in which the lower end portion of second support member 68 of the above embodiment is extended downward, first workpiece conveyance device 13A is fixed to an upper portion of second support member 304, and second workpiece conveyance device 13B is fixed to an extending lower end portion of second support member 304.

Each of first and second workpiece conveyance devices 13A and 13B has the same configuration as workpiece conveyance device 13 of the above embodiment except for first and second support members 303 and 304. First control section 25 (see FIG. 2) of first machine tool 11 is connected to processing box 79 and solenoid valve 77 (see FIG. 6) provided in each of first and second workpiece conveyance devices 13A and 13B, and can individually control each of first and second workpiece conveyance devices 13A and 13B. Workpiece conveyance device 301 can execute both the reversing control and the shift control based on the control of first control section 25.

For example, in the configuration example illustrated in FIG. 14, shift unit 63 is attached to first workpiece conveyance device 13A, and first and second reversing units 61 and 62 are attached to second workpiece conveyance device 13B. In this case, main body frame portion 65 of second workpiece conveyance device 13B is an example of a first frame portion of the present disclosure. Main body frame portion 65 of first workpiece conveyance device 13A is an example of a second frame portion of the present disclosure.

For example, when workpiece W is reversed and supplied from second machining section 31 of second machine tool 12 to first machining section 21 of first machine tool 11, first control section 25 executes the reversing control described above and moves first loader 22 to position P4 of second reversing unit 62 that receives workpiece W from first reversing unit 61. First control section 25 delivers workpiece W from second reversing unit 62 to first loader 22. For example, when workpiece W is supplied from second machining section 31 to first machining section 21 without being reversed, first control section 25 executes the above-described shift control. As a result, shift unit 63 moves to position P5 (position of the left end portion of first workpiece conveyance device 13A) illustrated in FIG. 14 while holding workpiece W. First control section 25 moves first loader 22 to position P5 and executes the delivery of workpiece W from shift unit 63 to first loader 22.

In such a configuration, first control section 25 can execute the reversing control and the shift control by selectively using first workpiece conveyance device 13A and second workpiece conveyance device 13B according to the content of the machining process or the like. For example, a case is considered, in which each of first and second machining sections 21 and 31 includes multiple spindle devices and the like, and workpiece W is exchanged between first and second machine tools 11 and 12 in one machining process. In such a case, in a certain process, workpiece W is delivered in a state where the reversing is not performed from first machine tool 11 to second machine tool 12, and in another process, the reversing from first machine tool 11 to second machine tool 12 is performed and workpiece W is delivered. Even in such a complicated machining process, workpiece W can be delivered between the machine tools by one workpiece conveyance device 301.

In the above embodiment, workpiece W is delivered from first reversing unit 61 to second reversing unit 62 in a state where the sliding movement of first reversing unit 61 is restricted by stopper 95, but the configuration is not limited to this. For example, first reversing unit 61 may be slid to a position where workpiece W clamped by first reversing unit 61 abuts on second reversing unit 62 (clamping claw 162). That is, the sliding movement of first reversing unit 61 may be restricted by second reversing unit 62. Then, workpiece W may be delivered from first reversing unit 61 to second reversing unit 62 in a state where the sliding movement of first reversing unit 61 is restricted by second reversing unit 62. Therefore, workpiece conveyance device 13 need not necessarily include stopper 95 and stopper hole 97. Similarly, when workpiece W is delivered from second reversing unit 62 to first reversing unit 61, the sliding movement of first reversing unit 61 may be restricted by workpiece W clamped by second reversing unit 62, and workpiece W may be delivered from second reversing unit 62 to first reversing unit 61.

In the above embodiment, first machine tool 11 including first machining section 21 and second machine tool 12 including second machining section 31 are separate devices (including separate control sections), but first machining sections 21, second machining sections 31, and workpiece conveyance device 13 may be disposed in one machine tool.

Workpiece conveyance device 13 to which first and second reversing units 61 and 62 are attached need not include rod-less cylinder 83 and rail member 91. For example, the distance between first reversing unit 61 and second reversing unit 62 in the left-right direction may be changed by the user adjusting the attachment position. Workpiece W may be delivered only by the rotation (autorotation) of first and second reversing units 61 and 62 without sliding first reversing unit 61 in the delivery of workpiece W.

In the above-described embodiment, air cylinders 103 and 143 are adopted as the fluid pressure cylinders of the present disclosure, but the configuration is not limited thereto, and other fluid pressure cylinders such as a hydraulic cylinder may be adopted.

The method of connecting air pipes 123 and 173 is not limited to the one touch joint, and may be a method of fixing the pipes by fastening a nut or the like.

Further, first and second machining sections 21 and 31 are not limited to machining sections using a turret device, and may be machining sections of a machining center. First and second machining sections 21 and 31 may have various configurations such as a horizontal lathe, a front lathe, a vertical lathe, a single-axis lathe, a biaxial lathe, a milling machine, and a ball machine.

### REFERENCE SIGNS LIST

10: machine tool, 11: first machine tool, 12: second machine tool, 13, 13A, 13B, 301: workpiece conveyance device, 15: air supply device (slide mechanism, fluid driving source), 21: first machining section, 22: first loader, 25: first control section (control section), 31: second machining section, 32: second loader, 61: first reversing unit, 62: second reversing unit, 63: shift unit, 65: main body frame portion (first frame portion and second frame portion in FIG. 14), 65A: tapped hole (second attachment section), 83: rod-less cylinder (slide mechanism), 85: cylinder main body (rail portion), 86: first table (first attachment section), 89: proximity sensor, 95: stopper, 97: stopper hole (stopper attachment section), 101: first link mechanism, 102: first clamping section, 103: air cylinder (first rotation drive section), 109: fastening member (first fastening member), 123: air pipe (first air pipe), 125: joint (first one touch joint), 141: second link mechanism, 142: second clamping section, 143: air cylinder (second rotation drive section), 151: spacer (second fastening member), 153: screw (second fastening member), 173: air pipe (second air pipe), 175: joint (second one touch joint), P1: first position, P2: second position, W: workpiece

1. A machine tool comprising:
a first loader configured to convey a workpiece to a first machining section configured to perform machining on the workpiece;
a second loader configured to convey the workpiece to a second machining section configured to perform machining on the workpiece;
a workpiece conveyance device configured to deliver the workpiece between the first loader and the second loader; and
a control section,
wherein a first reversing unit, a second reversing unit, and a shift unit are attachable to the workpiece conveyance device, and
the control section executes
a reversing control of, when the first reversing unit and the second reversing unit are attached, receiving the workpiece from the second loader to the first reversing unit, rotating the first reversing unit in a state of holding the received workpiece, delivering the workpiece from the rotated first reversing unit to the second reversing unit, rotating the second reversing unit in a state of holding the delivered workpiece, and delivering the workpiece from the rotated second reversing unit to the first loader, and
a shift control of, when the shift unit is attached, receiving the workpiece from the second loader to the shift unit and delivering the workpiece from the shift unit to the first loader while maintaining orientation of the received workpiece.

2. The machine tool according to claim 1,
wherein the workpiece conveyance device includes
a first attachment section to which only one of the first reversing unit and the shift unit is attachable, and
a second attachment section to and from which the second reversing unit is attachable and detachable.

3. The machine tool according to claim 2,
wherein the workpiece conveyance device includes
a slide mechanism configured to slide the first attachment section from a position separated from the second attachment section by a predetermined distance toward the second attachment section,
the first reversing unit delivers the workpiece to the second loader at a first position,
the second reversing unit delivers the workpiece to the first loader at a second position,
the shift unit is attached to the first attachment section in a state where the first reversing unit and the second reversing unit are removed, and
in the shift control, the control section receives the workpiece from the second loader to the shift unit at the first position, and then, causes the slide mechanism to slide the first attachment section to a position of the second attachment section, and delivers the workpiece from the shift unit to the first loader at the second position.

4. The machine tool according to claim 3,
wherein in the reversing control, the control section receives the workpiece from the second loader to the first reversing unit at the first position, and then rotates the first reversing unit, causes the slide mechanism to slide the first attachment section toward the second attachment section, and brings the rotated first reversing unit close to the second reversing unit.

5. The machine tool according to claim 4,
wherein the slide mechanism includes,
a rail portion on which the first attachment section is slidable,
a fluid driving source configured to slide the first attachment section along the rail portion in accordance with a fluid pressure, and
a stopper attachment section configured to attach a stopper between the first attachment section and the second attachment section,
in both of the reversing control and the shift control, the control section slides the first attachment section toward the second attachment section at the same fluid pressure, and
in the reversing control, when the first reversing unit is moved toward the second reversing unit in accordance with driving of the slide mechanism, the control section delivers the workpiece from the first reversing unit to the second reversing unit in a state where the sliding movement of the first reversing unit is restricted by the stopper attached to the stopper attachment section.

6. The machine tool according to claim 5,
wherein the slide mechanism includes a proximity sensor configured to output a signal corresponding to approach between the first reversing unit and the second reversing unit to the control section, and
in the reversing control, the control section detects that the first reversing unit approaches the second reversing unit based on the signal of the proximity sensor, and then, executes control for delivering the workpiece from the first reversing unit to the second reversing unit.

7. The machine tool according to claim 2,
wherein the first reversing unit includes
a first clamping section configured to clamp and hold the workpiece,
a first link mechanism configured to rotatably support the first clamping section, and
a first rotation drive section configured to rotate the first clamping section supported by the first link mechanism, and
the second reversing unit includes
a second clamping section configured to clamp and hold the workpiece,
a second link mechanism configured to rotatably support the second clamping section, and
a second rotation drive section configured to rotate the second clamping section supported by the second link mechanism.

8. The machine tool according to claim 7,
wherein the first link mechanism is fixed to the first attachment section by a first fastening member,
the second link mechanism is fixed to the second attachment section by a second fastening member,
the first rotation drive section is a fluid pressure cylinder and connected to a first air pipe connected to an air supply device by a first one touch joint, and
the second rotation drive section is a fluid pressure cylinder and connected to a second air pipe connected to the air supply device by a second one touch joint.

9. The machine tool according to claim 1,
wherein in the reversing control, the control section receives the workpiece from the second loader to the first reversing unit, and then, rotates the second reversing unit so that the second reversing unit faces the first reversing unit in accordance with the rotation of the first reversing unit in a state where the received workpiece is held, and executes control for delivering the workpiece from the rotated first reversing unit to the second reversing unit.

10. The machine tool according to claim 1, further comprising:
a first frame portion to which the first reversing unit and the second reversing unit are attached; and
a second frame portion to which the shift unit is attached,
wherein when the workpiece is reversed and supplied from the second machining section to the first machining section, the control section executes the reversing control and moves the first loader to a position of the second reversing unit to execute the delivery of the workpiece, and
when the workpiece is supplied from the second machining section to the first machining section without being reversed, the control section executes the shift control and moves the first loader to a position of the shift unit to execute the delivery of the workpiece.
